(19) United States
(12) Patent Application Publication
(10) Pub. No.: US 2022/0375489 A1
(43) Pub. Date: Nov. 24, 2022

(54) RESTORING APPARATUS, RESTORING METHOD, AND PROGRAM

(71) Applicant: NIPPON TELEGRAPH AND TELEPHONE CORPORATION, Tokyo (JP)

(72) Inventor: Satoru EMURA, Tokyo (JP)

(73) Assignee: NIPPON TELEGRAPH AND TELEPHONE CORPORATION, Tokyo (JP)

(21) Appl. No.: 17/619,618

(22) PCT Filed: Jun. 18, 2019
(86) PCT No.: PCT/JP2019/024058

§ 371 Date: Dec. 16, 2021

(51) Int. Cl. G10L 25/30; G10L 21/0232

(52) U.S. Cl. CPC G10L 25/30; G10L 21/0232

(57) ABSTRACT

A clipped signal is accurately restored with a constant computational amount. A frame division unit (11) generates input data including a post-clip signal and clip information representing a clipped part in the post-clip signal. A waveform restoration unit (12) estimates a pre-clip signal from the input data using a signal restoring neural network. Using a pre-clip signal, a post-clip signal, and clip information as learning data, the signal restoring neural network is made to learn to receive the input data as input, and output an estimated value of the pre-clip signal. A frame combination unit (13) combines frames of the pre-clip signal.

### TECHNICAL FIELD

The present invention relates to a technique for restoring a signal before clipping from a signal after clipping.

### BACKGROUND ART

When a signal is input and output between devices, a part of the signal, the amplitude of which is greater than the input and output ranges of the devices, is clipped to a certain value. Clipping can occur in a wide variety of situations, such as when a signal is obtained from a sensor, when a signal is output to some equipment, or when an analog signal is input to an A/D converter for digitization. Therefore, research has been conducted for restoring a signal waveform before clipping from a clipped signal.

As such a method, a method called SPADE (SParse Audio DEclipper) has been proposed (Non-Patent Literature 1). SPADE will be described below.

Note that the symbols “ ” and “\hat{ }” used in the text should originally be written directly above the immediately preceding character, but due to restrictions on the text notation, they are written immediately after the character. In mathematical expressions, these symbols are written at their original positions, that is, directly above the character. For example, “z ” is expressed by the following expression in mathematical expressions:

z̅ [Math. 1]

Further, for example, “z\hat{ }” is expressed by the following expression in mathematical expressions:

\hat{z} [Math. 2]

An original signal (a signal before clipping) is expressed by a signal vector x=[x₁, . . . , x_{N}], and a clipped signal is expressed by a signal vector y=[y₁, . . . , y_{N}] Each sample of a signal before and after clipping has the relationship of Expression (1):

$$[ Math . 3 ]$$

$${y}_{i} = \{ \begin{matrix}θ for {x}_{i} > θ , \\ {x}_{i} for \vert {x}_{i} \vert \leq θ , \\ - θ for {x}_{i} < - θ\end{matrix} \qquad ( 1 )$$

Here, θ is a clipping level. A signal sample after clipping belongs to one of a signal sample S₊ that is clipped at an upper limit, a signal sample Sᵣ that is not clipped, and a signal sample S₋ that is clipped at a lower limit.

In SPADE, a dictionary matrix D is defined first. Then, paying attention to a signal representation vector z obtained by multiplying the signal vector x by the inverse matrix D⁻¹ of the dictionary matrix D, the complexity of the signal is measured by the number of non-zero elements in z, that is, the L₀ norm ∥z∥₀ of z. A DFT matrix (discrete Fourier transform matrix), a DCT matrix (discrete cosine transform matrix), or the like is used as the dictionary matrix D.

In SPADE, the complexity of a signal before clipping is denoted by k, and a predetermined update amount s is assumed as the initial value of the complexity k. First, the input signal, that is, the signal y after clipping is converted into a signal representation vector z using D⁻¹. By leaving the k largest elements in absolute value in z and setting the other values to 0, it is converted into a signal representation vector z⁻ with a complexity of k. This operation is called hard thresholding, and is expressed by a mathematical expression as z⁻=Hₖ(z) (corresponding to step 2 of Table 1 below). Next, this signal representation vector z⁻ is multiplied by D to be converted into an estimated signal vector x⁻=Dz⁻. The estimated signal vector x⁻ is an estimation result of the signal vector x before clipping at this stage. Normally, there is a deviation between this estimated signal vector x⁻ and the input signal vector y even in the non-clip part. Therefore, a signal representation vector z\hat{ } that satisfies the following two conditions is determined (corresponding to step 3 of Table 1 below).

Condition 1: Clipped Dz\hat{ } coincides with y.

Condition 2: The distance between z\hat{ } and z is the smallest.

When the distance between z\hat{ } and z is greater than a predetermined value, it is determined that “a target signal cannot be represented due to insufficiency of the assumed complexity k of the signal” to increase the complexity k by the update amount s each time, and the above process is iterated.

When the above process is implemented using the optimization method ADMM (Non-Patent Literature 2), the algorithm in Table 1 can be obtained:

TABLE 1

| | |
|---|---|
| 1: | z̅⁽⁰⁾ = D*y, u⁽⁰⁾ = 0, i = 1, k = s |
| 2: | z̅⁽ⁱ⁾ = [symbol] ₖ (\hat{z}⁽ⁱ⁻¹⁾ + u⁽ⁱ⁻¹⁾) |
| 3: | \hat{z}⁽ⁱ⁾ = arg min \|\|z − (\ddot{z}⁽ⁱ⁾ − u⁽ⁱ⁻¹⁾)\|\|₂² |
| | subject to Dz in Γ(y) |
| 4: | if \|\|\hat{z}⁽ⁱ⁾ − z̅⁽ⁱ⁾\|\|₂ ≤ ϵ or i > max_iter then |
| 5: | terminate |
| 6: | else |
| 7: | u⁽ⁱ⁾ = u⁽ⁱ⁻¹⁾ + \hat{z}⁽ⁱ⁾ − z̅⁽ⁱ⁾ |
| 8: | i ← i + 1 |
| 9: | if i mod r = ^{I}0 then |
| 10: | k ← k + s |
| 11: | end if |
| 12: | go to 2 |
| 13: | end if |
| 14: | return x = D\hat{z}⁽ⁱ⁾ |

SPADE is used in combination with a normal frame signal process. That is, the input signal after clipping is divided into frames with a certain length having overlap, and after a windowing process is performed on each frame, the above SPADE process is applied. Then, a frame combination process is applied to the processing result, and a restored signal before clipping is obtained.

### CITATION LIST

### Non-Patent Literature

Non-Patent Literature 1: S. Kitic, N. Bertin, and R. Gribnoval, “Sparsity and cosparsity for audio declipping: a flexible non-convex approach”, The 12 th International conference on Latent Variable Analysis and Signal Separation (LVA/ICA2015), 2015.

Non-Patent Literature 2: S. Boyd, N. Parkikh, E. Chu, B. Peleato, and J. Eckstein, “Distributed optimization and statistical learning via the alternating direction method of multipliers”, Foundation and Trend in Machine Learning, vol. 3, no. 1, 2011.

### SUMMARY OF THE INVENTION

### Technical Problem

However, a problem with SPADE is that the computational amount fluctuates when it is necessary to restore the waveform of a sensor signal in real time. This is because SPADE proceeds with the waveform restoration process iteratively while sequentially increasing the assumed complexity k, and also because the complexity of the input signal is unknown in the first place and continually fluctuating. Further, another problem is that as the clipped part increases, the characteristics of the original signal are less likely to be reflected in the restored signal.

An object of the present invention is to realize a technique capable of accurately restoring a clipped signal with a constant computational amount in view of the above technical problems.

### Means for Solving the Problem

In order to solve the above problems, a restoration device according to an aspect of the present invention includes a restoration unit that estimates a pre-clip signal corresponding to a post-clip signal from input data including the post-clip signal and clip information representing a clipped part in the post-clip signal using a signal restoring neural network, wherein using a pre-clip signal, a post-clip signal corresponding to the pre-clip signal, and clip information on the post-clip signal as learning data, the signal restoring neural network is made to learn to receive the input data as input and output an estimated value of the pre-clip signal.

### Effects of the Invention

According to the restoration technique of the present invention, it is possible to accurately restore a clipped signal with a constant computational amount.

### BRIEF DESCRIPTION OF DRAWINGS

FIG. 1 is a diagram illustrating a functional configuration of a waveform restoration device.

FIG. 2 is a diagram illustrating a configuration of a waveform restoration unit.

FIG. 3 is a diagram illustrating a processing procedure of a waveform restoration method.

FIG. 4 is a diagram illustrating a functional configuration of a waveform restoration unit of a second embodiment.

FIG. 5 is a diagram illustrating a functional configuration of a computer.

### DESCRIPTION OF EMBODIMENTS

Embodiments of the present invention will be described below in detail. Note that components having the same function are given the same numeral in the drawings, and repeated explanation is omitted.

### First Embodiment

A signal restoration device (hereinafter referred to as “restoration device”) in a first embodiment is a signal processing device that restores a signal before clipping from a signal after clipping using a signal restoring neural network composed of a gated convolutional neural network (see, e.g., References 1, 2). Since the operation in a neural network is fixed, the computational amount of the overall signal restoration process by the signal restoring neural network is constant. Further, by making the signal restoring neural network perform learning sufficiently in advance using sufficient learning data, it can be expected that the characteristics of the signal before clipping are better reflected in the restored signal.

[Reference 1] Y. N. Dauphin, A. Fan, M. Auli, and D. Grangier, “Language Modeling with Gated Convolutional Networks,” arXiv:1612.08083, Submitted on 23 Dec. 2016 (v1).

[Reference 2] J. Yu, Z. Lin, J. Yang, X. Shen, X. Lu, and T. S. Hua ng, “Free-Form Image Inpainting with Gated Convolution,” arXiv:1806.0 3589, Submitted on 10 Jun. 2018.

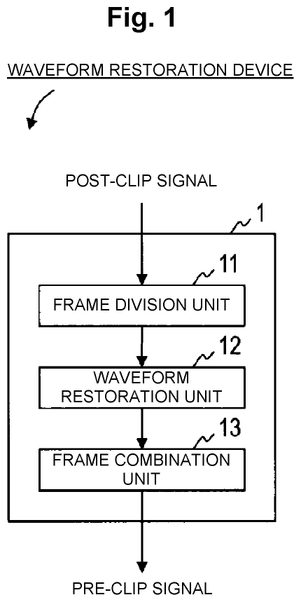

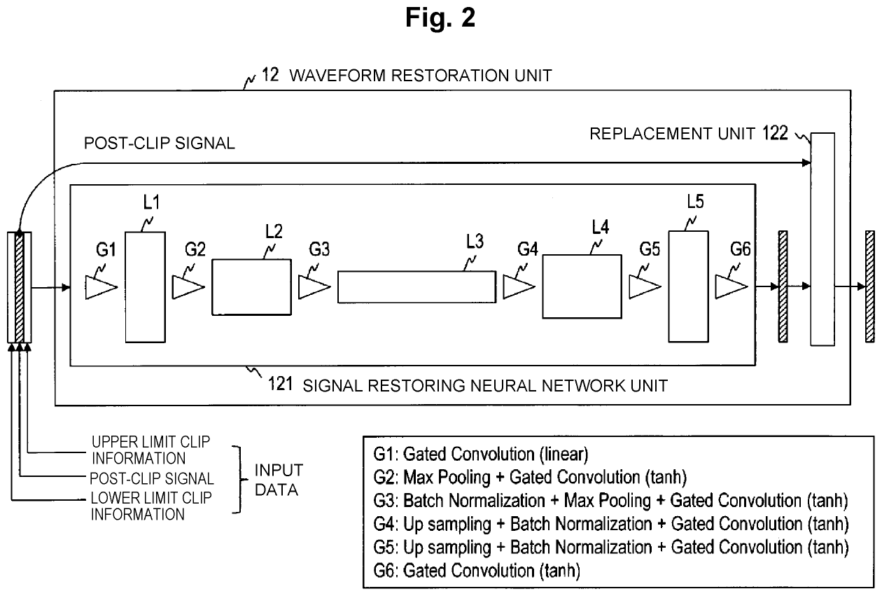

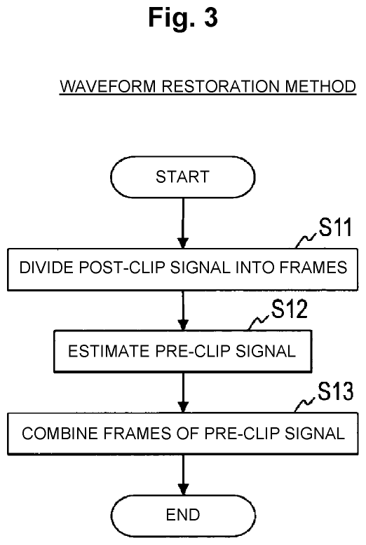

A waveform restoration device 1 of the first embodiment includes a frame division unit 11, a waveform restoration unit 12 (hereinafter also referred to as “restoration unit”), and a frame combination unit 13, as illustrated in FIG. 1. The waveform restoration unit 12 includes a signal restoring neural network 121 and a replacement unit 122 as illustrated in FIG. 2. This waveform restoration device 1 performs the process of each step illustrated in FIG. 3, thereby realizing a waveform restoration method of the first embodiment.

The waveform restoration device 1 is, for example, a special device that is configured by loading a special program onto a well-known or dedicated computer having a central processing unit (CPU), a main memory device (RAM: random access memory), and the like. The waveform restoration device 1 executes each process under the control of the central processing unit, for example. Data input to the waveform restoration device 1 and data obtained in each process are stored in, for example, the main memory device, and the data stored in the main memory device is read to the central processing unit as needed, and is used for other processes. At least a part of each processing unit of the waveform restoration device 1 may be made up of hardware such as an integrated circuit.

Referring to FIG. 2, it will be described how the input data is converted into intermediate data one after another and finally output within the signal restoring neural network 121.

First, in the previous stage (e.g., the frame division unit 11) of the signal restoring neural network 121, input data is formed from a vector of a post-clip signal input to the waveform restoration device 1, a vector of upper limit clip information, and a vector of lower limit clip information. The vector of the post-clip signal is an L-dimensional vector including a post-clip signal of L samples. The upper limit clip information is an L-dimensional vector in which 1 is set at positions where a signal sample equal to or greater than an upper limit value is present and 0 is set at the other positions. The lower limit clip information is an L-dimensional vector in which 1 is set at positions where a signal sample equal to or lower than a lower limit value is present and 0 is set at the other positions. That is, as shown in FIG. 2, an L×3 matrix formed by sandwiching the vector of the post-clip signal between the vector of the upper limit clip information and the vector of the lower limit clip information is the input data.

When the signal restoring neural network is learned, the above input data and a pre-clip signal are given as learning data. When estimation is performed using the learned signal restoring neural network, input data related to a post-clip signal to be restored is input, and its output is taken as an estimated value of the pre-clip signal. Finally, the replacement unit 122 replaces a part clipped by the upper or lower limit within the vector of the post-clip signal with the value estimated by the signal restoring neural network, and outputs it as a restored pre-clip signal.

The signal restoring neural network is composed of a multi-layer gated convolutional neural network. A convolutional neural network cuts input data (signal) into a plurality of pieces in the time direction, filters them, and passes them through an activation function, thereby outputting a feature vector. When the signal length L=1024, for example, 3-20 taps are used as the filter length. By increasing the number of filter types, the number of feature vectors, that is, the number of channels is increased. In FIG. 2, data (L1-L5) shown as a quadrangle is each intermediate data, its vertical width corresponds to the number of samples in the time direction, and its horizontal width corresponds to the number of channels. Conversion corresponding to one layer of a general convolutional neural network is expressed as the following expression with Y as an input vector:

h(Y)=tan h(Y*W+b) [Math. 4]

On the other hand, in a gated convolutional neural network, this conversion becomes the following expression:

$$h ( Y ) = σ ( Y * W + b ) ⊗ σ ( Y * V + c ) \qquad [ Math . 5 ]$$

$$Here ,$$

$$⊗ \qquad [ Math . 6 ]$$

is an element-wise product, a is an activation function, and W, b, V, and c are leaned parameters. In this embodiment, since both the input signal and the output signal take positive and negative values, a function that outputs positive and negative values (e.g., tan h) is used as the activation function.

The signal restoring neural network includes a process in which the post-clip signal is encoded to a higher-order feature amount and a process in which the higher-order feature amount is decoded to a restored signal, and an L-dimensional vector is finally output from the decoding process. In the encoding process, the number of filter types is increased to increase the number of channels, while max pooling is used to gradually decrease the number of samples in the time direction. In the decoding process, conversely, the number of filter types is decreased to decrease the number of channels, while up-sampling is used to gradually increase the number of samples in the time direction. Although FIG. 2 shows a configuration with five hidden layers, the number of layers in the present invention is not limited to this. Configurations with fewer layers and more layers are conceivable.

Note that gated convolutional neural networks, max pooling, and batch normalization are used for each of the conversions (G1-G6) from the input data to intermediate data, from intermediate data to intermediate data, and from intermediate data to an output as shown in FIG. 2. Further, the L1 norm of the difference signal between the signal before clipping and the restored signal is used for a cost function in learning the whole signal restoring neural network as in Reference 2.

Hereinafter, referring to FIG. 3, a processing procedure of a waveform restoration method executed by the waveform restoration device 1 of the first embodiment will be described.

The post-clip signal, the upper limit clip information on the post-clip signal, and the lower limit clip information on the post-clip signal are input to the waveform restoration device 1.

In step S11, the frame division unit 11 divides each of the input post-clip signal, upper limit clip information, and lower limit clip information into sets of L samples to generate the input data. That is, the input data is data in which the L-dimensional vector representing the post-clip signal of L samples, the L-dimensional vector representing the upper limit clip information corresponding to each sample of the post-clip signal, and the L-dimensional vector representing the lower limit clip information corresponding to each sample of the post-clip signal are combined as a set. More specifically, an L×3 matrix in which the L-dimensional vector of the post-clip signal is sandwiched between the L-dimensional vector of the upper limit clip information and the L-dimensional vector of the lower limit clip information is the input data. The frame division unit 11 sends the generated input data to the waveform restoration unit 12.

In step S12, the waveform restoration unit 12 estimates the pre-clip signal from the input data using the signal restoring neural network 121. That is, the waveform restoration unit 12 inputs the input data received from the frame division unit 11 to the signal restoring neural network 121, and causes the replacement unit 122 to replace a part clipped by the upper limit value or clipped by the lower limit value in the vector of the post-clip signal of the input data with the value estimated by the signal restoring neural network 121 to generate the vector of the pre-clip signal. The waveform restoration unit 12 sends the estimated vector of the pre-clip signal to the frame combination unit 13.

In step S13, the frame combination unit 13 applies a frame combination process to the estimated vector of the pre-clip signal to restore the pre-clip signal.

### Second Embodiment

Although the signal restoring neural network of the first embodiment restores a rough shape of a signal, the shapes of details tend to be less restored. Therefore, in a waveform restoration unit of the second embodiment, signal restoring neural networks in two stages are connected in series in order to increase the accuracy of restoring the shapes of details as shown in

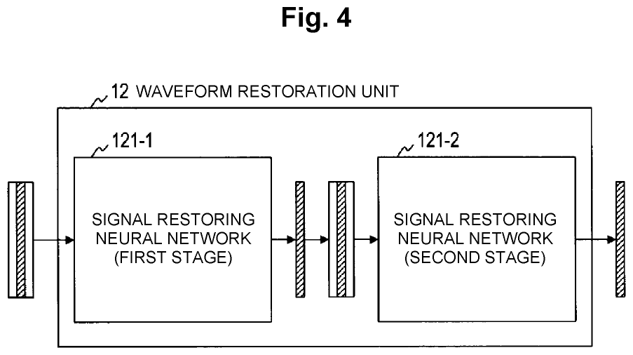

FIG. 4. That is, they are configured so that the signal vector restored by the signal restoring neural network 121-1 of the first embodiment is further subjected to the signal restoring neural network 121-2 in the second stage to estimate the vector of the pre-clip signal.

As in the first embodiment, the input data is formed by sandwiching the vector of the post-clip signal between the vector of the upper limit clip information and the vector of the lower limit clip information. When the signal length is L, the input data becomes an L×3 matrix. When the signal restoring neural network 121-2 in the second stage is learned, this input data and the pre-clip signal are given as learning data. After learning, when estimation is performed using the signal restoring neural networks, the input data is input to the signal restoring neural network 121-1 in the first stage, and the output of the signal restoring neural network 121-2 in the second stage is taken as an estimated value of the pre-clip signal.

The internal configuration of the signal restoring neural network 121-2 in the second stage is the same as that of the signal restoring neural network of the first embodiment shown in FIG. 2. That is, the signal restoring neural network 121-2 includes a process in which the signal after clipping is encoded to a higher-order feature amount and a process in which the higher-order feature amount is decoded to a restored signal, and an L-dimensional vector is finally output from the decoding process. The number of samples in the time direction and the number of channels of each intermediate data may be the same as or different from those of the signal restoring neural network 121-1 in the first stage. The number of layers may also be the same as or different from that of the signal restoring neural network 121-1 in the first stage.

### Modification of Second Embodiment

When restoration of the original signal is targeted not for a signal after clipping but for a signal containing missing parts, information of details of the original signal is more likely to be missed from the restored signal as well, as in the case of the signal after clipping. Therefore, when a signal containing missing parts is to be restored, the configuration of the second embodiment can be applied as well. In this case, the input data is an L×2 matrix including a signal vector containing missing parts and a missing information vector. By using the signal restoring neural network in the second stage as shown in FIG. 4, it is possible to estimate a restored signal with higher restoration accuracy from the estimated signal in the first stage.

### Points of the Present Invention

The points of the present invention are the following three points.

1. In a signal restoring neural network for restoring a post-clip signal using a gated convolutional neural network, input data is formed by sandwiching a vector of the post-clip signal between a vector of upper limit clip information and a vector of lower limit clip information.

2. Within the gated convolutional neural network, a function that outputs positive and negative values (tan h) is used as an activation function.

3. In order to increase the accuracy of restoring a signal, a configuration of signal restoring neural networks in two stages is employed. First, the signal restoring neural network in the first stage is made to perform learning. Using an estimation result after the learning, the signal restoring neural network in the second stage is made to perform learning.

Although embodiments of the present invention have been described above, it goes without saying that the specific configuration is not limited to these embodiments, and even if modifications in design or the like are made as appropriate within a range not departing from the spirit of the present invention, they are included in the present invention. The various processes described in the embodiments are not only executed in chronological order according to the order of description, but may also be executed in parallel or individually depending on the processing capability of a device that executes the processes or as required.

### Program and Recording Medium

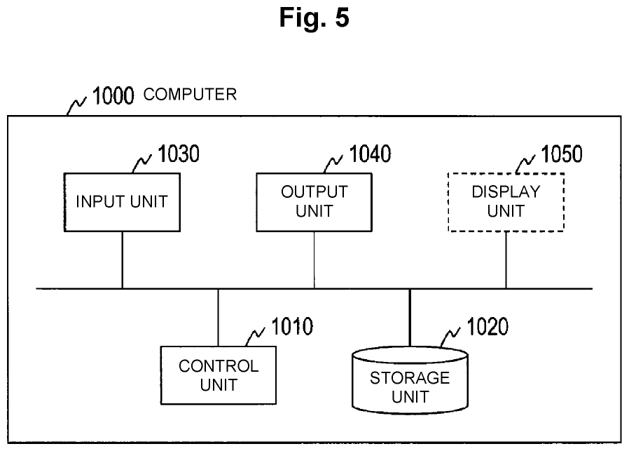

When the various processing functions in each device described in the above embodiments are implemented by a computer, the processing contents of the functions that each device should have are written by a program. Then, by loading this program onto a storage unit 1020 of a computer shown in FIG. 5 and causing a control unit 1010, an input unit 1030, an output unit 1040, and the like to run it, the various processing functions in each of the above devices are implemented on the computer.

This program in which the processing contents are written can be recorded in advance in a computer readable recording medium. The computer-readable recording medium may be any medium such as a magnetic recording device, an optical disc, a photomagnetic recording medium, and a semiconductor memory.

Further, this program is distributed by, for example, selling, transferring, or lending a portable recording medium such as a DVD or CD-ROM on which the program is recorded. Furthermore, a configuration is possible in which this program is distributed by storing in advance this program in a storage device of a server computer, and transferring the program from the server computer to another computer via a network.

For example, a computer that executes such a program first stores the program recorded on the portable recording medium or the program transferred from the server computer in its own storage device temporarily. Then, when executing a process, the computer reads the program stored in its own storage device, and executes the process according to the read program. Further, as another execution form of this program, a computer may read the program directly from the portable recording medium and execute the process according to the program, and furthermore, each time the program is transferred from the server computer to the computer, the process according to the received program may be executed sequentially. Further, in another configuration, the above processes may be executed by a so-called ASP (application service provider) type service that implements the processing functions not by transferring the program from the server computer to the computer but only by instructing its execution and acquiring the result. It is to be noted that the program in this form includes information to be used for processes by an electronic computer and equivalent to the program (such as data that is not direct commands to the computer but has properties defining processes by the computer).

Further, although the present device is configured by causing a predetermined program to be executed on the computer in this form, at least a part of these processing contents may be implemented in hardware.

1. A restoration device comprising circuitry configured to execute a method comprising:
estimating a pre-clip signal corresponding to a post-clip signal from input data including the post-clip signal and clip information representing a clipped part in the post-clip signal using a signal restoring neural network,
wherein using a pre-clip signal, a post-clip signal corresponding to the pre-clip signal, and clip information on the post-clip signal as learning data, the signal restoring neural network is made to learn to receive the input data as input and output an estimated value of the pre-clip signal.

2. The restoration device according to claim 1, wherein
the clip information comprises upper limit clip information representing a part clipped by an upper limit value and lower limit clip information representing a part clipped by a lower limit value.

3. The restoration device according to claim 2, wherein
the input data is formed by sandwiching the post-clip signal between the upper limit clip information and the lower limit clip information.

4. The restoration device according to claim 1, wherein
the signal restoring neural network is a gated convolutional neural network, and an activation function is a function that outputs positive and negative values.

5. The restoration device according to claim 1, wherein
the signal restoring neural network is connected in series in two stages, input data comprising an output of a signal restoring neural network in a first stage and the clip information is input to a signal restoring neural network in a second stage, and an output of the signal restoring neural network in the second stage is taken as an estimated value of the pre-clip signal.

6. A computer-implemented method for restoration, comprising
estimating a pre-clip signal corresponding to a post-clip signal from input data including the post-clip signal and clip information representing a clipped part in the post-clip signal using a signal restoring neural network,
wherein using a pre-clip signal, a post-clip signal corresponding to the pre-clip signal, and clip information on the post-clip signal as learning data, the signal restoring neural network is made to learn to receive the input data as input and output an estimated value of the pre-clip signal.

7. A computer-readable non-transitory recording medium storing computer-executable program instructions that when executed by a processor cause a computer system to execute a method comprising:
estimating a pre-clip signal corresponding to a post-clip signal from input data including the post-clip signal and clip information representing a clipped part in the post-clip signal using a signal restoring neural network,
wherein using a pre-clip signal, a post-clip signal corresponding to the pre-clip signal, and clip information on the post-clip signal as learning data, the signal restoring neural network is made to learn to receive the input data as input and output an estimated value of the pre-clip signal.

8. The restoration device according to claim 3, wherein
the signal restoring neural network is a gated convolutional neural network, and an activation function is a function that outputs positive and negative values.

9. The restoration device according to claim 4, wherein
the signal restoring neural network is connected in series in two stages, input data comprising an output of a signal restoring neural network in a first stage and the clip information is input to a signal restoring neural network in a second stage, and an output of the signal restoring neural network in the second stage is taken as an estimated value of the pre-clip signal.

10. The computer-implemented method according to claim 6, wherein
the clip information comprises upper limit clip information representing a part clipped by an upper limit value and lower limit clip information representing a part clipped by a lower limit value.

11. The computer-implemented method according to claim 6, wherein
the signal restoring neural network is a gated convolutional neural network, and an activation function is a function that outputs positive and negative values.

12. The computer-implemented method according to claim 6, wherein
the signal restoring neural network is connected in series in two stages, input data comprising an output of a signal restoring neural network in a first stage and the clip information is input to a signal restoring neural network in a second stage, and an output of the signal restoring neural network in the second stage is taken as an estimated value of the pre-clip signal.

13. The computer-readable non-transitory recording medium according to claim 7, wherein
the clip information comprises upper limit clip information representing a part clipped by an upper limit value and lower limit clip information representing a part clipped by a lower limit value.

14. The computer-readable non-transitory recording medium according to claim 7, wherein
the signal restoring neural network is a gated convolutional neural network, and an activation function is a function that outputs positive and negative values.

15. The computer-readable non-transitory recording medium according to claim 7, wherein
the signal restoring neural network is connected in series in two stages, input data comprising an output of a signal restoring neural network in a first stage and the clip information is input to a signal restoring neural network in a second stage, and an output of the signal restoring neural network in the second stage is taken as an estimated value of the pre-clip signal.

16. The computer-implemented method according to claim 10, wherein
the input data is formed by sandwiching the post-clip signal between the upper limit clip information and the lower limit clip information.

17. The computer-implemented method according to claim 11, wherein
the signal restoring neural network is connected in series in two stages, input data comprising an output of a signal restoring neural network in a first stage and the clip information is input to a signal restoring neural network in a second stage, and an output of the signal restoring neural network in the second stage is taken as an estimated value of the pre-clip signal.

18. The computer-readable non-transitory recording medium according to claim 13, wherein
the input data is formed by sandwiching the post-clip signal between the upper limit clip information and the lower limit clip information.

19. The computer-implemented method according to claim 16, wherein
the signal restoring neural network is a gated convolutional neural network, and an activation function is a function that outputs positive and negative values.

20. The computer-readable non-transitory recording medium according to claim 18, wherein the signal restoring neural network is a gated convolutional neural network, and an activation function is a function that outputs positive and negative values.
